(19) United States
(12) Patent Application Publication
(10) Pub. No.: US 2017/0089483 A1
(43) Pub. Date: Mar. 30, 2017

(54) SWITCHING VALVE

(71) Applicant: MITSUBISHI HEAVY INDUSTRIES, LTD., Tokyo (JP)

(72) Inventors: Hiroyuki AIHARA, Tokyo (JP); Akira KONDO, Tokyo (JP)

(21) Appl. No.: 15/126,438

(22) PCT Filed: Mar. 16, 2015
(86) PCT No.: PCT/JP2015/057763

§ 371 Date: Sep. 15, 2016

(30) Foreign Application Priority Data
Mar. 17, 2014 (JP) 2014-053903

(51) Int. Cl. F16K 31/06; H01F 7/16; H01F 7/08; F16K 25/00; H01F 7/06

(52) U.S. Cl. CPC F16K 31/0627; F16K 31/0679; F16K 25/005; H01F 7/064; H01F 7/081; H01F 7/16

(57) ABSTRACT

A switching valve has a cylinder, an end port, a side wall port, a sliding core, a poppet seal, a biasing member, and a sliding core internal channel. The cylinder guides the sliding core in a slidable manner, and has a valve seat. The poppet seal guided in a slidable manner in a sliding core inner space is biased toward a seal engagement protrusion by the biasing member. The poppet seal can be seated on the valve seat by a biasing force given by the biasing member to close a channel for controlled fluid, and can be separated from the valve seat to open the channel for the controlled fluid.

### TECHNICAL FIELD

The present invention relates to a switching valve that has high reliability even in environments which are not at room temperature, has superior durability, is compact, and has low power consumption.

### BACKGROUND ART

In JP 2000-016099 A (Patent Literature 1), an invention related to a poppet type check valve arranged at a lower end of a filler pipe of a vehicle fuel tank is disclosed. The invention of the check valve disclosed in Patent Literature 1 has a valve seat portion having tapered inner surface and a seal member disposed on a peripheral portion of a valve body. The invention has an object of mitigating an impact when the valve body collides with the valve seat portion.

On a peripheral portion of the seal member of the check valve disclosed in Patent Literature 1, a lip portion made of elastic material such as NBR (Nitrile Butadiene Rubber: Nitrile rubber) is disposed. Thus, a configuration in which the lip portion is seated on the valve seat portion is used. In closing the valve, the impact by the valve body moving is mitigated by elastic property of the seal member. Thus, it is possible to suppress deterioration of durability due to hitting wear between the valve body and the valve seat portion.

In JP H08-219302 A (Patent Literature 2), an invention related to a ball valve for controlling fluid which is cryogenic fluid or corrosive fluid is disclosed. The ball valve described in Patent Literature 2 has a ball-shaped valve body, an annular seal acting as a valve seat, a bellows for pushing the annular seal, and a cam follower.

According to the valve disclosed in Patent Literature 2, since the seal is pushed by the ball in closing the valve by deviating a centerline of rotation for the ball-shaped valve body from a geometric center of the ball-shaped valve body, proper seal surface pressure is secured using the bellows. On the other hand, it is possible to reduce the seal surface pressure in rotating the ball such that damage to the seal is suppressed, since the seal becomes in an uneven contact state in accordance with ball's rotation and the seal surface is being separated from the ball.

In JP H07-224961 A (Patent Literature 3), an invention for a poppet type electromagnetic valve for preventing occurrence of deterioration of valve body made of fluoric resin is disclosed. The poppet type electromagnetic valve described in Patent Literature 3 includes a coil having a hollow portion, a plunger slidably fitted in the hollow portion, a valve seat arranged between an inlet port and an outlet port, and a valve body contacted with or separated from the valve seat to close or open a flow path between the inlet port and the outlet port.

According to the electromagnetic valve described in Patent Literature 3, the valve body made of fluoric resin is disposed inside the plunger in a slidable manner, and is biased toward the valve seat by a biasing member. By adopting the above-mentioned configuration, an impact applied to the valve body in closing the valve is caused by a biasing force given by the biasing member. Thus, the impact applied to the valve body is mitigated, and it is possible to prevent the occurrence of the deterioration of the valve body.

### CITATION LIST

### Patent Literature

Patent Literature 1: JP 2000-016099 A
Patent Literature 2: JP H08-219302 A
Patent Literature 3: JP H07-224961 A

### SUMMARY OF THE INVENTION

Conventionally, as a switching valve for switching a flow path of fluid flowing in a pipe, spool valve or poppet valve is used. Regarding the spool valve, a spool having an annular groove in a peripheral portion is arranged, in a slidable manner, in a cylinder having ports extending therethrough toward an outside. Then, the spool is slided in a axial direction. Thus, the flow path is switched by communicating between the ports via the annular groove of the spool. On an outer peripheral portion of the spool, packing such as O-ring is attached for preventing leakage of the fluid.

The spool valve is used for controlling the fluid of low-temperature and high-pressure. However, in applications for performing switching control of cryogenic fluid having small molecules such as in applications for performing switching control of liquid hydrogen or liquid oxygen, a problem with regard to leakage of the controlled fluid through the packing occurs. A pushing force in a region where the packing is contact with an inner surface of the cylinder is determined by a crush amount and an elasticity of the packing. If the pushing force of the packing toward the inner surface of the cylinder is insufficient or the packing is hardened, there is a possibility that the controlled fluid is leaking out.

The elasticity of the packing changes depending on temperature, swelling, and degree of deterioration. Therefore, if the crush amount is set to a larger amount, resistance against the slide of the spool increases in accordance with the setting and it becomes necessary to use a more high-power solenoid. So, there is a tendency for the spool valve that the switching valve becomes large and power consumption is also increased. There are other problems for the packing used in the spool valve that an operating temperature range of the packing is narrow and durable life of the packing is short.

Note that the fluorine resin used in the valve body disclosed in the Patent Literature 3 has a heat-resistant property and a corrosion resistant property. However, the fluorine resin has little elasticity as compared to the rubber etc.

On the other hand, the poppet valve is characterized in that it is possible to adopt harder material for the valve body because a structure for pushing a port opening by the valve body is adopted. However, since an impact force as a result of sliding the valve body is directly applied to the valve seat, there is a possibility that the valve body is plastically deformed in accordance with repetitive use and a seal property is reduced.

In recent years, a commercial rocket to carry a plurality of satellites toward a plurality of orbits, respectively, with one launch is expected. For this purpose, it is necessary to provide a switching valve that can correspond to a long-time mission, has superior durability, and has low power consumption. In addition, in order to reduce possibility of occurring malfunction even when vibration is generated in starting a rocket engine, it is effective that weight of a movable portion, which moves in a switching operation, is further reduced.

An object of the present invention is to provide a switching valve that has high reliability even in environments which are not at room temperature, has superior durability, is compact, and has low power consumption.

A switching valve according to some embodiments has a cylinder, a sliding core, a poppet seal, a seal engagement protrusion, a biasing member, a valve seat, an end port, a sliding core internal channel, a sliding core penetrating channel, a side wall communication channel and a side wall port. The sliding core slides with respect to an inner surface of the cylinder, and slides in a given axial direction between a first end portion of the cylinder and a second end portion of the cylinder. Note that the sliding core includes a sliding core inner space. The poppet seal moves with respect to an inner surface of the sliding core and moves in the axial direction. The seal engagement protrusion protrudes toward an opening formed in the sliding core on a first end portion side of the cylinder so as to prevent the poppet seal from falling off. The biasing member is provided in the sliding core inner space for biasing the poppet seal toward the seal engagement protrusion. The valve seat is formed in the first end portion of the cylinder such that the poppet seal can be seated on the valve seat. The end port is formed in the first end portion of the cylinder and it penetrates through the valve seat for communicating with an outside of the cylinder. The sliding core internal channel is formed in the sliding core and communicates with the opening. The sliding core penetrating channel is provided to penetrate through a side wall of the sliding core such that the sliding core internal channel and an outer periphery of the sliding core communicate with each other. The side wall communication channel is provided between the inner surface of the cylinder and an outer surface of the sliding core so as to communicate with the sliding core penetrating channel. The side wall port is formed in a side wall of the cylinder for communicating the side wall communication channel and an outside of the cylinder with each other. The switching valve according to some embodiment is switchable between a first keeping state and a second state. Note that, in the first keeping state, the poppet seal is contact with the end port such that the end port and the side wall port do not communicate with each other. In the second state, the poppet seal is separated from the end port such that the end port and the side wall port communicate with each other.

The switching valve according to some embodiment may further include a sliding core biasing member for biasing the sliding core toward the first end portion of the cylinder in the first keeping state and for biasing the sliding core toward the second end portion of the cylinder in the second state.

Regarding the switching valve according to some embodiment, the sliding core biasing member may include an inversion type disc spring. The switching valve according to some embodiment may further include an outer receiving member for the inversion type disc spring connecting an outer peripheral portion of the inversion type disc spring to the inner surface of the cylinder, and an inner receiving member for the inversion type disc spring connecting an inner peripheral portion of the inversion type disc spring to the sliding core.

Regarding the switching valve according to some embodiment, the sliding core may include magnetic material. The switching valve according to some embodiment may further include a first driving coil and a second driving coil. Note that the first driving coil is provided on the first end portion side of the cylinder and attracts the sliding core toward the first end portion side by exciting the magnetic material. The second driving coil is provided on the second end portion side of the cylinder and attracts the sliding core toward the second end portion side by exciting the magnetic material.

The switching valve according to some embodiment may further include a first bobbin, a second bobbin, a first outer ring and a second outer ring. Note that the first bobbin is provided on an outer surface of the cylinder and supports the first driving coil. The second bobbin is provided on the outer surface of the cylinder and supports the second driving coil. The first outer ring, which is made of magnetic material, is provided on an outer peripheral portion of the first bobbin for protecting the first driving coil and acts as a part of a first magnetic circuit when the first driving coil is excited. The second outer ring, which is made of magnetic material, is provided on an outer peripheral portion of the second bobbin for protecting the second driving coil and acts as a part of a second magnetic circuit when the second driving coil is excited. Regarding the switching valve according to some embodiment, the cylinder may be made of non-magnetic material which magnetically separates the first magnetic circuit from the second magnetic circuit.

Regarding the switching valve according to some embodiment, the poppet seal may be made of heat resistant resin or metal usable both in a low-temperature environment and in a high-temperature environment.

Regarding the switching valve according to some embodiment, the biasing member may include a coil spring. The switching valve according to some embodiment may further include a pre-load shim for adjusting a pre-load of the coil spring.

The switching valve according to some embodiment may further include a second sliding core inner space, a second poppet seal, a second biasing member, a second seal engagement protrusion, a second valve seat, a second end port, and a second sliding core internal channel. Note that the second sliding core inner space is formed in the sliding core. The second poppet seal slides in the second sliding core inner space, and slides in the axial direction. The second biasing member is provided in the second sliding core inner space and biases the second poppet seal toward a second opening formed in the sliding core on the second end portion side of the cylinder. The second engagement protrusion protrudes toward the second opening so as to prevent the second poppet seal from falling off. The second valve seat is formed in the second end portion of the cylinder such that the second poppet seal can be seated on the second valve seat. The second end port is formed in the second end portion of the cylinder and is formed to penetrate through the second valve seat for communicating with an outside of the cylinder. The second sliding core internal channel is formed in the sliding core and communicates with the second opening. The second sliding core internal channel and the outer periphery of the sliding core communicate with each other via the sliding core penetrating channel. In the first keeping state, the second poppet seal is separated from the second end port such that the second end port and the side wall port communicate with each other. In the second state, the second poppet seal is contact with the second end port such that the second end port and the side wall port do not communicate with each other.

Regarding the switching valve according to some embodiment, the second poppet seal may be made of heat resistant resin or metal usable both in the low-temperature environment and in the high-temperature environment.

Regarding the switching valve according to some embodiment, the second biasing member may include a second coil spring. The switching valve according to some embodiment may further include a second pre-load shim for adjusting a pre-load of the second coil spring.

The switching valve according to the present invention has advantages of having high reliability even in environments which are not at room temperature, having superior durability, being compact, and having low power consumption.

### BRIEF DESCRIPTION OF THE DRAWINGS

FIG. 1 is a cross-sectional view for illustrating a configuration example of a three-port double-latch type electromagnetic valve in a first keeping state to which a switching valve of some embodiment is applied.

FIG. 2 is an external perspective view of an end face portion of a sliding core to be used for the switching valve of some embodiment.

FIG. 3 is a schematic diagram for illustrating an operation of the switching valve shown in FIG. 1.

FIG. 4 is a cross-sectional view for illustrating the configuration example of the three-port double-latch type electromagnetic valve in a second state to which the switching valve of some embodiment is applied.

FIG. 5 is a schematic diagram for illustrating the operation of the switching valve shown in FIG. 4.

### DESCRIPTION OF EMBODIMENTS

With reference to the accompanying drawings, some embodiments of the switching valve according to the present invention will be described below.

### (Configuration of Switching Valve 10)

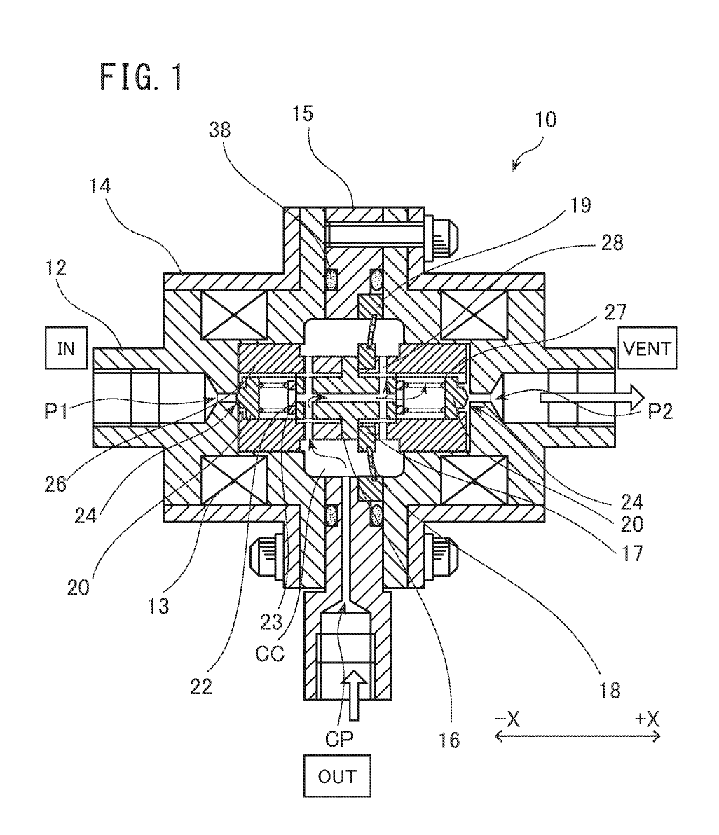

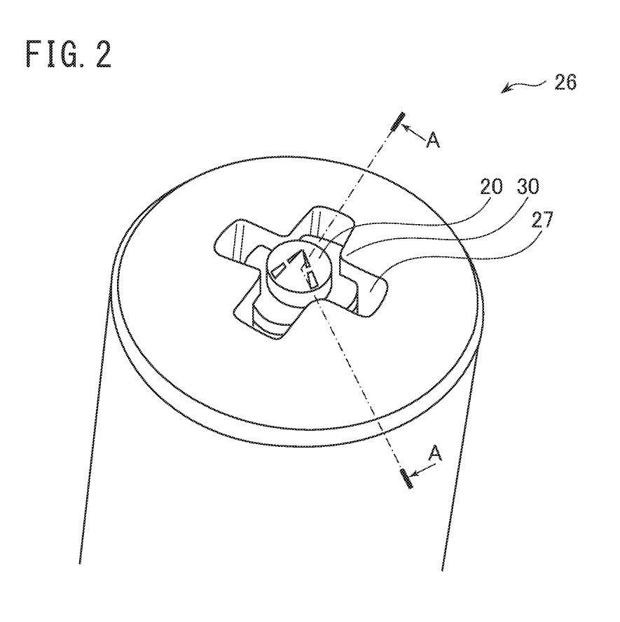

FIG. 1 is the cross-sectional view for illustrating the configuration example of the three-port double-latch type electromagnetic valve in the first keeping state to which the switching valve of some embodiment is applied. FIG. 2 is the external perspective view of the end face portion of the sliding core to be used for the switching valve of some embodiment. FIG. 1 is the cross-sectional view taken along line A-A in FIG. 2 when viewed from the direction indicated by the arrows.

The switching valve 10 shown in FIG. 1 and FIG. 2 is a three-port type valve with which it is possible to control cryogenic fluid such as liquid oxygen and liquid hydrogen, or control high-temperature fluid up to about 200 degrees Celsius. These three ports are, hereinafter, referred to as a first end port P1, a second end port P2 and a side wall port CP, respectively.

Elements of the switching valve 10 will be explained.

The switching valve 10 includes a cylinder, a sliding core, and a sliding core biasing member. Note that all of the first end port P1, the second end port P2, and the side wall port CP are provided in the cylinder.

The cylinder includes a body 15, a first cylinder 12A, a second cylinder 12B, a first O-ring 38A, a second O-ring 38B, a first driving coil 13A, a second driving coil 13B, a first valve seat 24A, a second valve seat 24B, and an outer receiving member 19 for a disc spring.

The sliding core includes a coupling rod 16, a first sliding core 26A, a second sliding core 26B, a first poppet seal 20A, a second poppet seal 20B, a first biasing member 22A, a second biasing member 22B, a first pre-load shim 23A, a second pre-load shim 23B, and an inner receiving member 17 for the disc spring.

Inside the cylinder, an inner space, which is referred to as cylinder inner space, is provided. The first end port P1 is provided in a first end portion of the cylinder, and communicates with an outside of the cylinder. Similarly, the second end port P2 is provided in a second end portion of the cylinder, and communicates with an outside of the cylinder.

In the cylinder inner space, a space referred to as side wall communication channel CC is provided. The side wall port CP is provided in a side wall of the cylinder, and the side wall communication channel CC and an outside of the cylinder communicate with each other via the side wall port CP.

Inside the first sliding core 26A, an inner space, which is referred to as first sliding core inner space, is provided. The first sliding core has a first opening portion which is opened to an outside of the first sliding core 26A. In the first opening portion, a first seal engagement protrusion 30 is provided.

Similarly, inside the second sliding core 26B, an inner space, which is referred to as second sliding core inner space, is provided. The second sliding core has a second opening portion which is opened to an outside of the second sliding core 26B. In the second opening portion, a second seal engagement protrusion is provided.

Connection relation of the respective component shown in FIG. 1 and FIG. 2 will be explained.

In one embodiment shown in FIG. 1, the first cylinder 12A and second cylinder 12B are arranged on the right side of the switching valve 10 and on the left side of the switching valve 10 (−X direction and +X direction shown in FIG. 1), respectively. The first cylinder 12A and the second cylinder 12B are coupled through the body 15 provided at an intermediate portion of the switching valve 10. At a connection part between the first cylinder 12A and the body 15, the first O-ring 38A is provided, and at a connection part between the second cylinder 12B and the body 15, the second O-ring 38B is provided. Thus, it is possible to prevent the used fluid from leaking out from the switching valve 10. In an intermediate portion of the body 15, the side wall communication channel CC for communicating the cylinder inner space and the side wall port CP with each other is formed.

The cylinder includes an inner surface which slidably guides the sliding core in the axial direction (−X direction, +X direction shown in FIG. 1). The sliding core reciprocates, in the axial direction, between the first end of the cylinder and the second end of the cylinder. If a part of the cylinder inner space is formed in two cylinders 12A, 12B, a part of the side wall communication channel CC, which communicates with the side wall port CP outside, is formed in two cylinders 12A, 12B.

In the end portion of the cylinder on the first cylinder side 12A, the first end port P1 is formed on the outer side and the first valve seat 24A is formed on the inner side. The first end port P1 penetrates through the first valve seat 24A and communicates with outside of the cylinder.

Similarly, in the end portion of the cylinder on the second cylinder side 12B, the second end port P2 is formed on the outer side and the second valve seat 24B is formed on the inner side. The second end port P2 penetrates through the second valve seat 24B and communicates with outside of the cylinder.

At an outer periphery of the first cylinder 12A, a bobbin around which the first drive coil 13A is wound is arranged. In the embodiment shown in FIG. 1, a first outer ring 14A is disposed on an outer peripheral portion of the first cylinder 12A, and covers the first driving coil 13A. The first outer ring 14A constitutes a part of a magnetic circuit which is generated when the first driving coil 13A is excited. Note that if the first outer ring 14A is made of magnetic material having corrosion-resistant property such as SUS 430 (Stainless Steel), special surface coating for corrosion-resistance can be omitted.

Note that configuration, arrangement and function of the second cylinder 12B, second driving coil 13B and second outer ring 14B are similar with the configuration, arrangement and function of the first cylinder 12A, first driving coil 13A and first outer ring 14A, respectively. So, a detailed explanation thereof will be omitted.

Further, if the body 15 is made of non-magnetic material, it is possible to separate a magnetic circuit generated in the first cylinder 12A from a magnetic circuit generated in the second cylinder 12B when the first driving coil 13A and the second driving coil 13B are excited. Thus, it is possible to output a driving force to be applied to the sliding core independently for the right side and the left side, respectively.

Regarding the sliding core shown in FIG. 1 and FIG. 2, the first sliding core 26A and the second sliding core 26B are made of magnetic material. Therefore, by exciting either one of the first driving coil 13A or the second driving coil 13B, the sliding core slides, in the cylinder inner space, in the axial direction, that is, −X direction or +X direction shown in FIG. 1.

Inside the first sliding core 26A, that is, inside the first sliding core inner space, the first poppet seal 20A, the first biasing member 22A and the first pre-load shim 23A are disposed. An inner surface of the first sliding core slidably guides the first poppet seal 20A in the axial direction. At the first opening portion of the first sliding core, the first seal engagement protrusion 30 protrudes for preventing the first poppet seal 20A from falling off. In FIG. 2, the embodiment in which a plurality of the first seal engagement protrusions 30 protrudes toward a central portion at four locations in the end face of the first sliding core 26A is illustrated. However, the number of the first seal engagement protrusions 30 is not limited to four. In addition, a shape of the protrusion is not limited to the shape illustrated in FIG. 2.

Similarly, inside the second sliding core 26B, that is, inside the second sliding core inner space, the second poppet seal 20B, the second biasing member 22B and the second pre-load shim 23B are disposed. An inner surface of the second sliding core slidably guides the second poppet seal 20B in the axial direction. At the second opening portion of the second sliding core, the second seal engagement protrusion protrudes for preventing the second poppet seal 20B from falling off. Details of the number and shape of the second seal engagement protrusion are similar with those of the first seal engagement protrusion 30. So, a detailed explanation thereof will be omitted.

In a configuration example shown in FIG. 1, the first biasing member 22A is formed of a coil spring. The first pre-load shim 23A is a member for fine-tuning a pushing force of the first poppet seal 20A seated on the first valve seat 24A of the first cylinder 12A by adjusting a pre-load of the first biasing member 22A. When a thick first pre-load shim 23A is used, the pushing force of the first poppet seal 20A against the first valve seat 24A is increased by shortening the first biasing member 22A. Thus, it is possible to increase a surface pressure. On the contrary, when a thin first pre-load shim 23A is used, the pushing force of the first poppet seal 20A against the first valve seat 24A is reduced. Thus, it is possible to reduce the surface pressure. The pushing force of the first poppet seal 20A against the first valve seat 24A can be set appropriately in accordance with kinds of materials, physical properties and the desirable surface pressure of the first poppet seal 20A.

Configuration, arrangement and function of the second biasing member 22B, second pre-load shim 23B and second valve seat 24B are similar with the configuration, arrangement and function of the first biasing member 22A, first pre-load shim 23A and first valve seat 24A, respectively. So, a detailed explanation thereof will be omitted.

In the embodiment shown in FIG. 1, the first sliding core 26A and the second sliding core 26B are connected to each other via the coupling rod 16 which is disposed therebetween. For example, if a decomposable structure such as a screwed connection between the coupling rod 16 and each of the first sliding core 26A and the second sliding core 26B is used, it is possible to easily adjust a thickness of the first pre-load shim 23A and a thickness of the second pre-load shim 23B, and easily exchange the first poppet seal 20A and the second poppet seal 20B, and so on. Further, according to the embodiment shown in FIG. 1, adjustment of the pushing forces of the first poppet seal 20A and the second poppet seal 20B against the first valve seat 24A and the second valve seal 24B, respectively, can be performed only in the sliding core. It contributes to down-sizing of the switching valve 10.

In the embodiment shown in FIG. 1 and FIG. 2, a seating portion of the first poppet seal 20A has a convex tapered shape. On the first valve seat 24A side, it is possible that the first valve seat 24A side has a concave tapered shape which corresponds to the convex tapered shape of the first poppet seal 20A. A contact width between the first poppet seal 20A and the first valve seat 24A can be set appropriately in accordance with respective material of the first poppet seal 20A and the first valve seat 24A. The shape of the first poppet seal 20A is not limited to the tapered shape, and the shape of the first valve seat 24A is not limited to the tapered shape. However, when the first poppet seal 20A and the first valve seat 24A have the tapered shape, it is possible that flow of the controlled fluid is less likely to be interfered. Thus, it is possible to reduce pressure loss of the controlled fluid. Note that if a seating surface of the first poppet seal 20A is formed in a planner shape, impinging jet stream is generated when a space between the first poppet seal 20A and the first valve seat 24A is opened. Thus, there is a possibility that the pressure loss is increased. Influence of the pressure loss caused by the impinging jet stream is likely to become conspicuous particularly when flow rate of the controlled fluid is high.

Configuration, arrangement and function of the second poppet seal 20B and the second valve seat 24B are similar with the configuration, arrangement and function of the first poppet seal 20A and the first valve seat 24A.

In the embodiment shown in FIG. 1, in an intermediate portion of the coupling rod 16, a central channel in which the controlled fluid flows and a penetrating channel for communicating the central channel and a sliding core penetrating channel 28 with each other are formed.

As shown in FIG. 1 and FIG. 2, in the inner surface of the first sliding core 26A, a groove as a first sliding core internal channel 27A communicating with the first opening portion is formed. Similarly, in the inner surface of the second sliding core 26B, a groove as a second sliding core internal channel 27B communicating with the second opening portion is formed. In addition, in the sliding core, the sliding core penetrating channel 28 is formed to pass through from the outer periphery to the first sliding core internal channel 27A and the second sliding core internal channel 27B. Thereby, it is possible that a flow path, through the first valve seat 24A and the side wall communication channel CC, between the first end port and the side wall port CP can be opened in a state in which the end face of the first sliding core 26A is separated from the end portion of the cylinder. Similarly, it is possible that a flow path, through the second valve seat 24B and the side wall communication channel CC, between the second end port and the side wall port CP can be opened in a state in which the end face of the second sliding core 26B is separated from the end portion of the cylinder.

The sliding core biasing member 18 is, for example, an inversion type disc spring. The sliding core biasing member 18 is a biasing member (a part of a latch mechanism) for enabling double-latch operation between a first keeping state in which the sliding core is kept biased in −X direction (toward the first end port P1 side) and a second keeping state in which the sliding core is kept biased in +X direction (toward the second end port P2 side). An outer peripheral portion of the sliding core biasing member 18 is fixed at the inner side of the cylinder via the outer receiving member 19 for the disc spring. An inner peripheral portion of the sliding core biasing member 18 is fixed at the outer side of the sliding core via the inner receiving member 17 for the disc spring.

In the structure shown in FIG. 1, since the sliding core biasing member 18 is disposed in the side wall communication channel CC, a hole passing through from −X direction side to +X direction side may be formed in portions of the body 15, the first cylinder 12A and the second cylinder 12B between inside of the first O-ring 38A and the second O-ring 38B and the outer periphery of the outer receiving member 19 for the disc spring in order to reduce flow resistance of the controlled fluid. Note that in place of the sliding core biasing member 18 (the disc spring) shown in FIG. 1, a diaphragm spring, a latch mechanism using a permanent magnet, a manual type latch mechanism, a latch mechanism using a ball plunger, or other latch mechanism can be used.

### (Operation of Switching Valve 10)

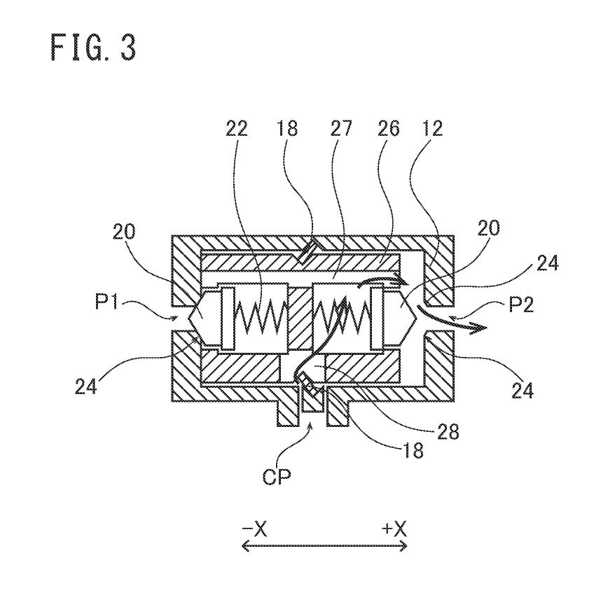

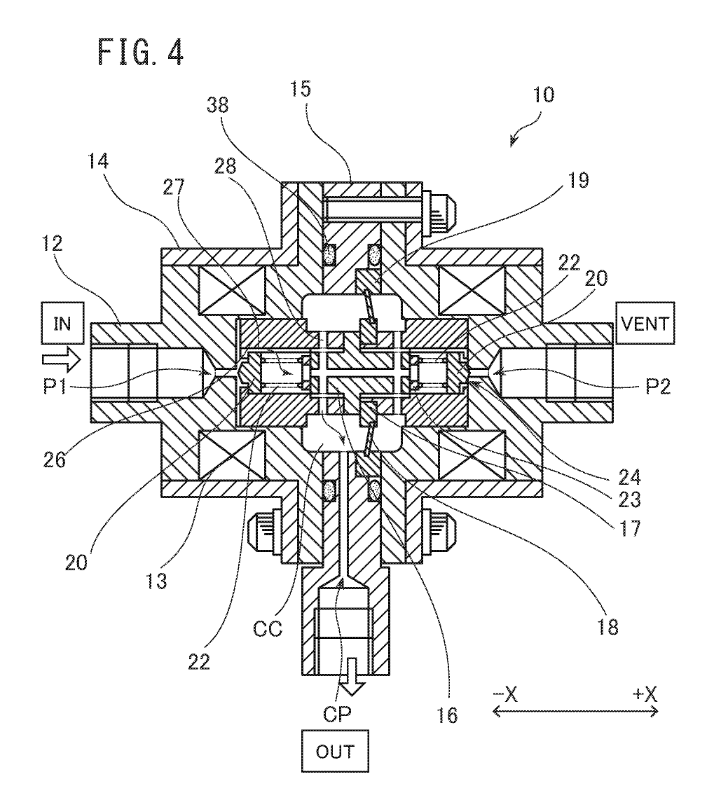

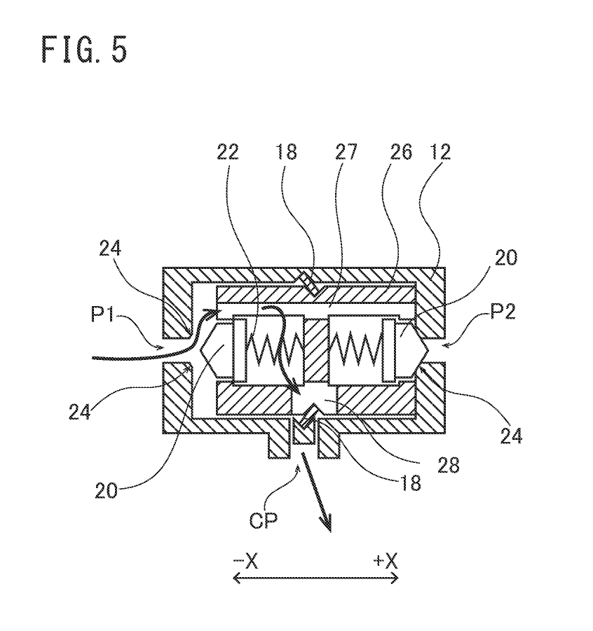

Next, the operation of the switching valve 10 will be explained with reference to FIG. 1 and FIGS. 3 to 5. FIG. 3 is the schematic diagram for illustrating the operation of the switching valve 10 shown in FIG. 1. FIG. 4 is the cross-sectional view for illustrating the configuration example of the three-port double-latch type electromagnetic valve in the second state to which the switching valve 10 of some embodiments is applied. FIG. 5 is the schematic diagram for illustrating the operation of the switching valve 10 shown in FIG. 4.

In FIG. 3 and FIG. 5, the sliding core 26 is illustrated while a combination of the first sliding core 26A, the coupling rod 16 and the second sliding core 26B is simplified. Similarly, in FIG. 3 and FIG. 5, the cylinder 12 is illustrated while a combination of the first cylinder 12A, the body 15 and the second cylinder 12B is simplified.

In FIG. 3, the first keeping state, which is already shown in FIG. 1, is illustrated. In the first keeping state, the sliding core 26 is kept on the first end port P1 side, that is, the sliding core has been moved in the −X direction shown in FIG. 3 and has been held.

In FIG. 4 and FIG. 5, the second keeping state is illustrated. In the second keeping state, the sliding core 26 is kept on the second end port P2 side, that is, the sliding core has been moved in the +X direction shown in FIG. 5 and has been held.

As shown in FIG. 1 and FIG. 3, in the first keeping state in which the sliding core 26 has been moved in −X direction, the first poppet seal 20A on −X direction side (the first end port P1 side) is seated on the first valve seat 24A, that is, the first poppet seal 20A is contact with the first end port P1. Thereby, the flow path between the first end port P1 and the side wall port CP is closed. At this time, the second poppet seal 20B on +X direction side (the second end port P2 side) is separated from the second valve seat 24B while the second poppet seal 20B is engaged with the second seal engagement protrusion. Thereby, the flow path between the second end port P2 and the side wall port CP is opened through the second valve seat 24B, the second sliding core internal channel 27B, the sliding core penetrating channel 28, and the side wall communication channel CC.

In the present embodiment, since the flow path between the second end port P2 and the side wall port CP is opened through the second sliding core internal channel 27B formed in the sliding core 26, it is possible to reduce an outer diameter of the switching valve 10 to a minimum size required. Thus, it is possible to reduce the size and weight of the switching valve 10. In addition, in the present embodiment, since flowing and blocking the controlled fluid are preformed using the first poppet seal 20A and the second poppet seal 20B disposed on both end portions of the sliding core 26, respectively, it is possible to adopt a configuration in which packing such as O-ring is not disposed on the outer periphery of the sliding core 26. Thereby, the friction between the cylinder 12 and the outer periphery of the sliding core 26 can be reduced. Thus, it is possible to reduce sizes of the first driving coil 13A and the second driving coil 13B which drive the sliding core 26 and reduce power consumption thereof.

As shown in FIG. 4 and FIG. 5, in the second keeping state in which the sliding core 26 has been moved in +X direction, the second poppet seal 20B on +X direction side (the second end port P2 side) is seated on the second valve seat 24B, that is, the second poppet seal 20B is contact with the second end port P2. Thereby, the flow path between the second end port P2 and the side wall port CP is closed. On the other hand, the first poppet seal 20A on −X direction side (the first end port P1 side) is separated from the first valve seat 24A while the first poppet seal 20A is engaged with the first seal engagement protrusion 30. Thereby, the flow path between the first end port P1 and the side wall port CP is opened through the first valve seat 24A, the first sliding core internal channel 27A, the sliding core penetrating channel 28, and the side wall communication channel CC. Note that, as shown in FIG. 5, it is possible to adopt a configuration in which the flow path between the first sliding core internal channel 27A and the first end port P1 does not include the side wall communication channel CC.

### Other Embodiments

In the above-mentioned embodiments, embodiments in which solenoids for exciting the first driving coil 13A and the second driving coil 13B are used as a power source to slide the sliding core 26 have been explained. In place of using these solenoids, an operated valve with which gas or liquid is used as the power source to move the sliding core 26, a pilot valve, or a mechanical valve with which a structure of moving the sliding core mechanically can be used.

Moreover, in the above-mentioned embodiments, the three-way valve in which the first valve seat 24A and the second valve seat 24B, and the first end port P1 and the second end port P2 are arranged on both end portions of the cylinder 12, respectively are illustrated. However, embodiments are not limited to the three-way valve. Some embodiment can be applied to a two-way valve. In addition, embodiments are not limited to the switching valve with which the double-latch operation is performed. Embodiments can be applied to a single-latch type switching valve using coil spring, etc. Moreover, some embodiments can be applied to a normally open type switching valve, normally closed type switching valve, alternate type switching valve, or momentary switching valve.

As the material of the first poppet seal 20A and the second poppet seal 20B, heat-resistant plastic, rubber or the like which is usable at a low or high temperature can be used. For example, super heat-resistant plastic such as wholly aromatic polyimide resin, aromatic polyether ketone such as polyether ether ketone (PEEK), polychloro trifluoroethylene (trifluoroethylene resin: PCTFE), polytetrafluoroethylene (tetrafluoroethylene resin: PTFE) can be used. In addition, depending on the practical application, various types of materials such as metal usable at the low or high temperature can be used. As an example of wholly aromatic polyimide resin, VESPEL (registered trademark) can be used.

Note that, high-temperature-side heat resistance temperature of the switching valve 10 is restricted by heat resistance temperature of conducting wire (about 220 degrees Celsius) included in the first drive coil 13A and the second driving coil 13B. It is possible to further increase the heat resistance temperature of the switching valve 10 by, for example, adding a cooling structure for the first driving coil 13A and the second driving coil 13B to the first cylinder 12A and the second cylinder 12B around which the first driving coil 13A and the second driving coil 13B are wound, respectively.

As mentioned above, the switching valve has been explained with reference to some embodiments. However, the present invention is not limited to the above-mentioned embodiments. The above-mentioned embodiments can be variously modified. It is possible to combine a technical feature of one embodiment with a technical feature of another embodiment.

This application claims a priority based on Japan Patent Application No. JP 2014-053903 filed on Mar. 17, 2014, the disclosure of which is hereby incorporated by reference herein in its entirety.

1. A switching valve comprising:
a cylinder;
a sliding core slidable with respect to an inner surface of the cylinder in a given axial direction between a first end portion of the cylinder and a second end portion of the cylinder, the sliding core having a sliding core inner space;
a poppet seal slidable with respect to an inner surface of the sliding core in the axial direction;
a seal engagement protrusion protruding toward an opening formed in the sliding core on a first end portion side of the cylinder so as to prevent the poppet seal from falling off;
a biasing member disposed in the sliding core inner space for biasing the poppet seal toward the seal engagement protrusion;
a valve seat formed in the first end portion of the cylinder such that the poppet seal can be seated on the valve seat;
an end port formed in the first end portion of the cylinder and penetrating through the valve seat for communicating with an outside of the cylinder;
a sliding core internal channel formed in the sliding core and configured to communicate with the opening;
a sliding core penetrating channel penetrating through a side wall of the sliding core such that the sliding core internal channel and an outer periphery of the sliding core communicate with each other;
a side wall communication channel disposed between the inner surface of the cylinder and an outer surface of the sliding core so as to communicate with the sliding core penetrating channel; and
a side wall port formed in a side wall of the cylinder for communicating the side wall communication channel and an outside of the cylinder with each other,
wherein the poppet seal is switchable between a first keeping state in which the poppet seal is contact with the end port such that the end port and the side wall port do not communicate with each other and a second state in which the poppet seal is separated from the end port such that the end port and the side wall port communicate with each other.

2. The switching valve according to claim 1, further comprising:
a sliding core biasing member for biasing the sliding core toward the first end portion of the cylinder in the first keeping state and for biasing the sliding core toward the second end portion of the cylinder in the second state.

3. The switching valve according to claim 2, wherein the sliding core biasing member comprises:
an inversion type disc spring;
an outer receiving member for the inversion type disc spring connecting an outer peripheral portion of the inversion type disc spring to the inner surface of the cylinder; and
an inner receiving member for the inversion type disc spring connecting an inner peripheral portion of the inversion type disc spring to the sliding core.

4. The switching valve according to claim 1, wherein the sliding core includes magnetic material,
the switching valve further comprising:
a first driving coil disposed on the first end portion side of the cylinder and configured to attract the sliding core toward the first end portion side by exciting the magnetic material; and
a second driving coil disposed on the second end portion side of the cylinder and configured to attract the sliding core toward the second end portion side by exciting the magnetic material.

5. The switching valve according to claim 4, further comprising:
a first bobbin disposed on an outer surface of the cylinder and supporting the first driving coil;
a second bobbin disposed on the outer surface of the cylinder and supporting the second driving coil;
a first outer ring, which is made of magnetic material, disposed on an outer peripheral portion of the first bobbin for protecting the first driving coil and configured to act as a part of a first magnetic circuit when the first driving coil is excited; and
a second outer ring, which is made of magnetic material, disposed on an outer peripheral portion of the second bobbin for protecting the second driving coil and configured to act as a part of a second magnetic circuit when the second driving coil is excited,
wherein the cylinder is made of non-magnetic material which magnetically separates the first magnetic circuit from the second magnetic circuit.

6. The switching valve according to claim 1, wherein the poppet seal is made of heat resistant resin or metal usable both in a low-temperature environment and in a high-temperature environment.

7. The switching valve according to claim 1, wherein the biasing member comprises a coil spring,
the switching valve further comprising:
a pre-load shim for adjusting a pre-load of the coil spring.

8. The switching valve according to claim 1,
wherein the sliding core has a second sliding core inner space,
the switching valve further comprising:
a second poppet seal slidable in the second sliding core inner space in the axial direction;
a second biasing member disposed in the second sliding core inner space for biasing the second poppet seal toward a second opening formed in the sliding core on a second end portion side of the cylinder;
a second engagement protrusion protruding toward the second opening so as to prevent the second poppet seal from falling off;
a second valve seat formed in the second end portion of the cylinder such that the second poppet seal can be seated on the second valve seat;
a second end port formed in the second end portion of the cylinder and penetrating through the second valve seat for communicating with an outside of the cylinder; and
a second sliding core internal channel formed in the sliding core and configured to communicate with the second opening;
wherein the second sliding core internal channel and the outer periphery of the sliding core communicate with each other via the sliding core penetrating channel,
wherein the second poppet seal is separated from the second end port such that the second end port and the side wall port communicate with each other in the first keeping state, and
wherein the second poppet seal is contact with the second end port such that the second end port and the side wall port do not communicate with each other in the second state.

9. The switching valve according to claim 8, wherein the second poppet seal is made of heat resistant resin or metal usable both in the low-temperature environment and in the high-temperature environment.

10. The switching valve according to claim 8, wherein the second biasing member comprises a second coil spring,
the switching valve further comprising:
a second pre-load shim for adjusting a pre-load of the second coil spring.
